(19) United States
(12) Patent Application Publication
(10) Pub. No.: US 2010/0259076 A1
(43) Pub. Date: Oct. 14, 2010

(54) Reinforced Energy Absorption Device and Assembly

(75) Inventors: Julien Meghira, Archueil (FR); Joël Canteleux, Gallardon (FR); Pierre Bequet, Pussay (FR); Serge Pignaud, Gif Sur Yvette (FR)

Correspondence Address: MILLER, MATTHIAS & HULL, ONE NORTH FRANKLIN STREET, SUITE 2350, CHICAGO, IL, 60606, US

(73) Assignee: Faurecia Sieges d'Automobile, Nanterre (FR)

(21) Appl. No.: 12/747,229

(22) PCT Filed: Dec. 8, 2008
(86) PCT No.: PCT/FR08/52249

§ 371 Date: Jun. 10, 2010

(30) Foreign Application Priority Data
Dec. 11, 2007 (FR) 0708627

(51) Int. Cl. B60N 2/42

(52) U.S. Cl. 297/216.1

(57) ABSTRACT

A device for absorbing energy by deformation, in particular for a motor vehicle seat, in the event of an impact, the energy absorption device comprising: a plate of substantially constant thickness comprising at least a first cutout and a second cutout which are separated by a bridge; and a rod extending through the first cutout wherein the bridge comprises a collar having, at least locally, a thickness greater than the thickness of the plate.

The invention relates to a device for absorbing energy by deformation, in particular for a motor vehicle seat in the event of an impact and an assembly comprising two energy absorption devices.

More precisely, the invention concerns an energy absorption device of the type comprising:
a plate of substantially constant thickness, featuring a first cut-out and a second cut-out separated by a bridge, and
a rod which extends through the first cut-out.

An energy absorption device of this type is commonly known and is especially disclosed in the document US2004/0061364.

The invention aims to reduce the cost and to improve the sturdiness of this type of energy absorption device.

To achieve this, in compliance with the invention, the bridge comprises a collar, which has at least locally a thickness which is greater than the thickness of the plate.

The term collar designates a curved zone of material, in this case a zone made of the same material as the plate. Consequently, the plate is reinforced at the area of the collar, and therefore its thickness may be reduced. The material cost is thus also reduced, as well as the weight of the device. Furthermore, said plate may be used locally for the energy absorption device and more globally form a seat structure flange without generating significant weight or material cost for the seat.

According to one complementary characteristic, the collar is preferably annular and is on the edge of the first cut-out.

Consequently the guiding and centring of the rod in the first cut-out are also improved.

According to yet another complementary characteristic, the collar preferably extends substantially perpendicularly to the main part of the plate and locally increases the thickness of said plate by between 100% and 200%.

The thickness of the plate is therefore doubled or tripled at the bridge section, which represents a substantial increase in resistance for a given thickness of plate and thus also permits a reduction in material and therefore a reduction in weight.

Preferably, the thickness of the main part of the plate is between 1.5 and 2.5 millimetres, and the bridge has a thickness of between 3 and 6 millimetres.

According to another characteristic which complies with the invention, the plate is work hardened at the collar to increase its hardness.

The working of the material to form the collar permits the hardness of the collar to be increased locally, which further enhances its resistance.

The invention also relates to an energy absorption assembly. In compliance with the invention, the energy absorption assembly includes the above-mentioned device which forms a first energy absorption device and a second energy absorption device both intended to be interposed between a first element and a second element in order to hold them with respect to one another by absorbing the high stresses exerted between said first and second elements, wherein said first energy absorption device and said second energy absorption device are distant from one another and are adapted so that they both deform under the action of a same stress exerted between the first element and the second element.

Consequently, the energy to be absorbed in the impact may be distributed in order to reduce the thickness of the plate of each energy absorption device.

According to one complementary characteristic, the energy absorption assembly advantageously has the following characteristics:
the second energy absorption device also has a rod and a plate, wherein the plate comprises at least a first cut-out and a second cut-out separated by a bridge, wherein the rod extends through the first cut-out,
for each energy absorption device, the rod and the plate are stationary, one to the first element and the other to the second element;
the bridge of the first energy absorption device opposes the rotation of the second element with respect to the first element around the axis of the rod of the second energy absorption device in an energy absorption direction, and
the bridge of the second energy absorption device opposes the rotation of the second element with respect to the first element around the axis of the rod of the first energy absorption device also in the energy absorption direction.

According to one complementary characteristic that is compliant with the invention, the bridge of the first energy absorption device and the bridge of the second energy absorption device preferably each comprise a slot inside which the rod of the corresponding energy absorption device is designed to pass.

According to another complementary characteristic that is compliant with the invention, the first energy absorption device and the second energy absorption device are preferably adapted so that the bridge of the second energy absorption device breaks before the bridge of the first energy absorption device breaks.

The absorption of the energy is thus more constant and better controlled, especially when the bridges have a slot.

Other characteristics and advantages of the invention will become clearer upon reading the following detailed description, in reference to the appended drawings among which:

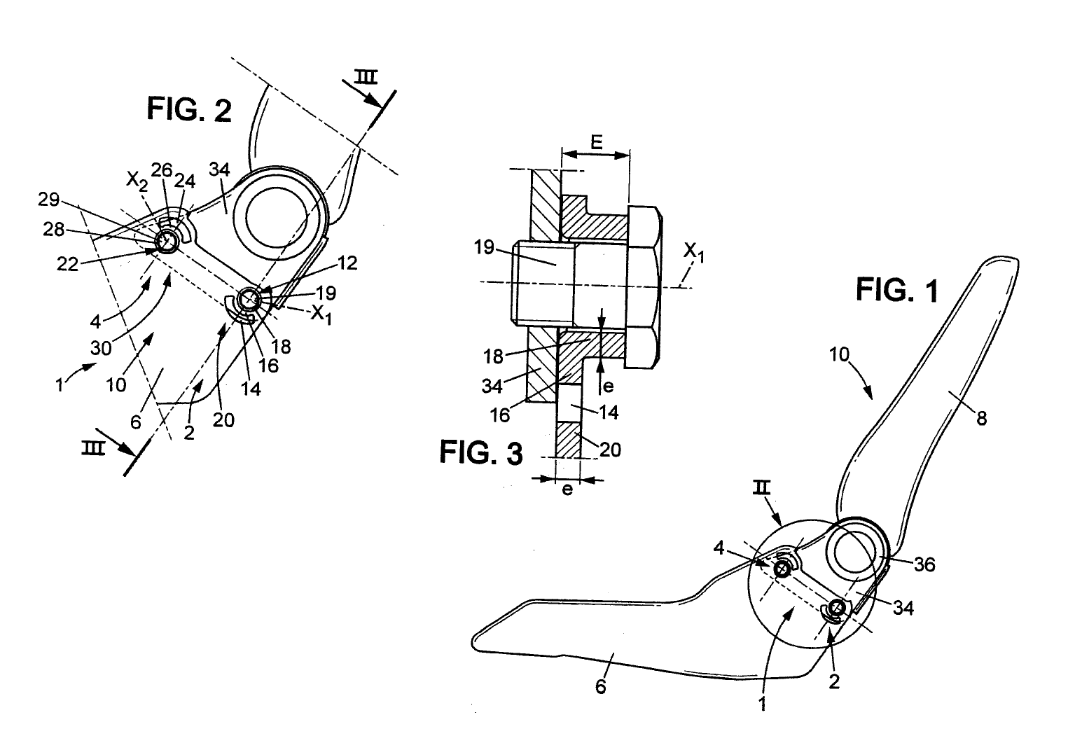

FIG. 1 illustrates an energy absorption assembly which complies with the invention;

FIG. 2 is an enlarged view of the zone marked II in FIG. 1, before impact;

FIG. 3 is a cross-sectional view along the line III-III in FIG. 2;

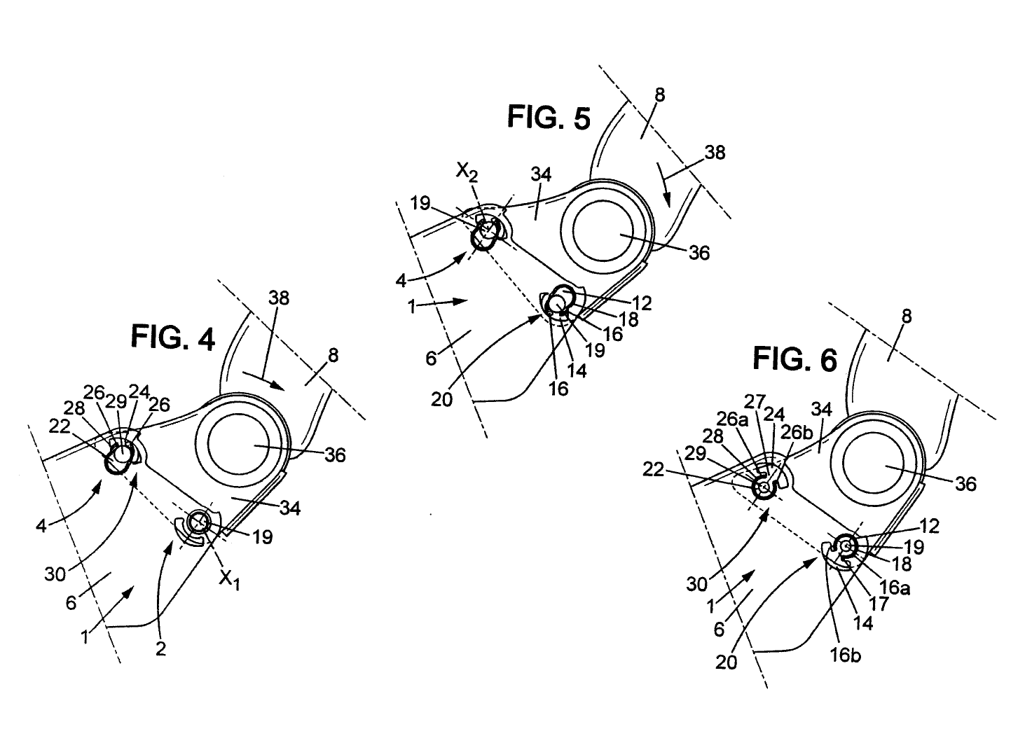

FIG. 4 illustrates the energy absorption assembly in compliance with FIG. 2, during the absorption of the impact;

FIG. 5 illustrates the energy absorption assembly in compliance with FIG. 2, at the end of the absorption of the impact;

FIG. 6 illustrates a variant of the energy absorption assembly, in compliance with FIG. 2.

FIGS. 1 to 5 illustrate a seat 10 for a motor vehicle comprising, at each of its lateral ends, a seat structure flange 6, a seat back structure flange 8, a flange forming an adaptor 34 joined to the seat back structure flange 8 by an articulated joint 36 and an energy absorption assembly 1 interposed between the adaptor 34 and the seat structure flange 6.

The energy absorption assembly 1 comprises a first energy absorption device 2 and a second energy absorption device 4 which are distant from one another, generally substantially around ten centimetres from one another.

The elements of the second energy absorption device 4 corresponding to those of the first energy absorption device 2 have an reference number incremented by 10 with respect to those of the first energy absorption device 2.

The first energy absorption device 2 and the second energy absorption device 4 each comprise a screw with a rod 19, 29, extending along an axis X₁, X₂, and a plate 20, 30, which has a first cut-out 12, 22, through which the rod 19, 29 passes and a second cut-out 14, 24, separated from the first cut-out by a bridge 16, 26.

As illustrated in FIG. 3, the plate 20, 30 of each energy absorption device 2, 4, is held against the adaptor 34 by the screws. The rod 19, 29 of each of the screws is advantageously made stationary with respect to the adaptor 34 by welding. To make it easier to understand, the screws have not been shown on FIGS. 1, 2, 4 and 5.

In the embodiment illustrated, the plate 20, 30 of each energy absorption device 2, 4, is integrated into the seat flange 6 of which it forms a portion. As a variant, the plates 20, 30 may be formed by added elements which are fixed onto the seat structure flange 6.

For each energy absorption device 2, 4, the first cut-out 12, 22, has a substantially circular form and on its edge has a collar 18, 28, which is formed by the deformation of the plate 20, 30 and is curved substantially at 90° with respect to the plane of the plate 20, 30. Each collar 18, 28, is thus annular and more precisely has a substantially tubular form extending along the axis X₁, X₂ of the corresponding rod 19, 29.

Outside of the collar 18, 28, each of the plates 20, 30, has a thickness e that is substantially constant. The collar 18, 28 has a height E which forms a local increase in the thickness of the plate 20, 30. Radially to the axis X₁, X₂ of the rod 19, 29, the collar 18, 28, has a thickness e substantially corresponding to the thickness of the plate 20, 30.

Preferably, the plate 20, 30 has a thickness e outside of the collar 18, 28, of between 1.5 and 2.5 millimetres, and at the collar a thickness of between 4 and 6 millimetres.

The deformation of the plate 20, 30 causes by work hardening a greater hardness of the collars 18, 28 with respect to the rest of the plate 20, 30.

In the event of an impact causing a high stress to the seat back structure 8, the structure of the seat back 8 and the adaptor 34 tend to move with respect to the seat structure 8. Due to the action of the rod 29, the bridge 26 of the second energy absorption device 4 is deformed elastically, then plastically, until it possibly breaks depending to the intensity of the stress.

As indicated by the arrow 38 in FIG. 4, the seat back structure via the adaptor 34 tends to lower towards the rear by rotation (clockwise in this figure) around the X₁ axis of the rod 19 of the first energy absorption device 2.

Then, if the impact is very intense, the rod 19 of the first energy absorption device 2 deforms the bridge 16 possibly until it breaks. As indicated by the arrow 38 in FIG. 5, the seat back structure 9 via the adaptor 34 lowers towards the rear by rotation (also clockwise), around the X₂ axis of the rod 29 of the second energy absorption device 4.

The form of the second cut-out 14, 24, of each energy absorption device 2, 4, is such that the bridge 16, 26 is narrower at each of its ends, thus creating the start of a rupture at each end of the bridge 16, 26, which improves the effort and repeatability (consistency of the result for a series of devices).

FIG. 6 illustrates a variant of an embodiment which is distinguished from the embodiment illustrated in FIGS. 1 to 5 in that the bridge of the first energy absorption device 2 and the bridge of the second energy absorption device 4 separating the first cut-out 12, 22 from the second cut-out 14, 24, comprise two portions 16a, 16b; 26a, 26b, separated by a slot 17, 27 joining the first cut-out 12, 22 to the second cut-out 14, 24.

As the slot 17, 27 is slightly narrower than the rod 19, 29, the movement of the rod 19, 29, of the first energy absorption device 2 and of the second energy absorption device 4 causes the deformation of the portions 16a, 16b; 26a, 26b of the bridges similarly to the manner described in relation to FIGS. 4 and 5.

Preferably, the slot 17, 27 has a width that measures less than half of the diameter of the rod 19, 29. Consequently, for a rod 19, 29 of 12 millimetres in diameter, the slot preferably has a width of between 2 and 6 millimetres.

The positioning of a slot 17, 27 tangentially to the movement of a rod 19, 29, by rotation around the axis X₁, X₂ of the other rod favours the rotation of the adaptor 34 and the seat back structure 8 around the axis of the other energy absorption device.

Preferably, so that the second energy absorption device 4 is deformed first, the slot 27 of the second energy absorption device 4 extends tangentially to the movement of the rod 29 by rotation around the axis X₁ of the rod 19 of the first energy absorption device 2 and only after the rotation of the adaptor 34 around the axis X₁, when the rod 29 of the second energy absorption device 4 is substantially in the second slot 24, wherein the slot 17 of the first energy absorption device extends substantially tangentially to the movement of the rod 19 by rotation around the axis X₂ of the rod 29 of the second energy absorption device.

1.) A device for absorbing energy by deformation, in particular for a motor vehicle seat in the event of an impact, wherein the energy absorption device comprises:
a plate of substantially constant thickness, featuring at least a first cut-out and a second cut-out separated by a bridge and
a rod which extends through the first cut-out
wherein the bridge comprises a collar which has at least locally a thickness which is greater than the thickness of the plate

2.) The energy absorption device according to claim 1, wherein the collar (18) is annular and is on the edge of the first cut-out

3.) The energy absorption device according to claim 1 wherein the plate comprises main part and the collar, and the collar extends substantially perpendicularly to the main part of the plate and locally increases the thickness of said plate by between 100% and 200%.

4.) The energy absorption device according to claim 3, wherein the thickness of the main part of the plate is between 1.5 and 2.5 millimetres, and the bridge has a thickness of between 3 and 6 millimetres.

5.) The energy absorption device according to, claim 1 wherein the plate is work hardened at the collar to increase its hardness.

6.) An energy absorption assembly comprising a first energy absorption device according to claim 1 and a second energy absorption device, both intended to be interposed between a first element and a second element in order to hold them with respect to one another by absorbing the high stresses exerted between said first and second elements, wherein said first energy absorption device and said second energy absorption device are distant from one another and are adapted so that they both deform under the action of a same stress exerted between the first element and the second element

7. The energy absorption assembly according to claim 6, wherein:
the second energy absorption device also has a rod and a plate, wherein the plate comprises at least a first cut-out and a second cut-out separated by a bridge, wherein the rod extends through the first cut-out,
the rod and the plate are stationary, one to the first element and the other to the second element;
the bridge of the first energy absorption device opposes the rotation of the second element with respect to the first element around the axis of the rod of the second energy absorption device in a energy absorption direction, and
the bridge of the second energy absorption device opposes the rotation of the second element with respect to the first element around the axis of the rod of the first energy absorption device also in the energy absorption direction.

8.) The energy absorption assembly according to claim 7, wherein the bridge of the first energy absorption device and the bridge of the second energy absorption device preferably each comprise a slot inside which the rod of the corresponding energy absorption device is designed to pass.

9. The energy absorption assembly according to claim 7, wherein the first energy absorption device and the second energy absorption device are adapted so that the bridge of the second energy absorption device breaks before the bridge of the first energy absorption device breaks.
